(19) United States
(12) Patent Application Publication
(10) Pub. No.: US 2010/0195259 A1
(43) Pub. Date: Aug. 5, 2010

(54) Device for improving fuel efficiency of automobile engine

(76) Inventor: Dean Johnson, Edmonton (CA)

Correspondence Address: L.C. Begin & Associates, PLLC., 510 Highland Ave., PMB 403, Milford, MI, 48381, US

(21) Appl. No.: 12/701,317

(22) Filed: Feb. 5, 2010

Related U.S. Application Data
(60) Provisional application No. 61/150,032, filed on Feb. 5, 2009.

(51) Int. Cl. H05F 3/00

(52) U.S. Cl. 361/216

(57) ABSTRACT

One embodiment of a device for improving fuel efficiency of an automobile engine having a plurality of firing cylinders with a plurality of firing caps may include a discharging circuit. The discharging circuit may have an input terminal capable of being electrically coupled to the plurality of firing caps and configured to receive excess energy from the automobile engine. The discharging circuit may also have one or more output terminals capable of being electrically coupled to ground. The discharging unit may be capable of controllably discharging the excess energy into the ground through the output terminal, and the discharge of the excess energy into the ground may prevent accumulation of the excess energy in the automobile engine, thereby improving the fuel efficiency of the automobile engine.

### CROSS REFERENCE TO RELATED APPLICATION

The application claims benefit of U.S. Provisional Application No. 61/150,032 filed on Feb. 5, 2009, the disclosure of which is incorporated by reference.

### FIELD OF THE DISCLOSURE

The present disclosure relates to devices for improving fuel efficiency of automobile engines, and more particularly, to a device that provides a controlled discharge of excess energy of the automobile engine into ground.

### BACKGROUND OF THE DISCLOSURE

Increasing dependence on fossil fuels for powering automobile engines may lead to various problems. One such problem may be shortage in supply of these fuels. This shortage may result in increased fuel prices world over.

The increased fuel prices may impact financial budgets of people, especially automobile owners. The impact may become much more severe for people, who own heavy automobiles, such as trucks, and sports utility vehicles (SUVs). These heavy vehicles may be bulky and usually carry heavy loads. Therefore, such automobiles may have high fuel consumption leading to high fuel bills for their owners.

Accordingly, automobile manufacturers and automobile owners have been looking for ways to increase the fuel efficiency of the automobile engines. The automobile manufacturers may have been fairly successful in developing fuel efficient automobile engine technologies. However, these fuel efficient engine technologies are expensive, thereby providing financial relief to the automobile owners only in the long run.

### SUMMARY OF THE DISCLOSURE

One embodiment of a device for improving fuel efficiency of an automobile engine having a plurality of firing cylinders with a plurality of firing caps may include a discharging circuit. The discharging circuit may have an input terminal capable of being electrically coupled to the plurality of firing caps and configured to receive excess energy from the automobile engine. The discharging circuit may also have one or more output terminals capable of being electrically coupled to ground. The discharging unit may be capable of controllably discharging the excess energy into the ground through the output terminal, and the discharge of the excess energy into the ground may prevent accumulation of the excess energy in the automobile engine, thereby improving the fuel efficiency of the automobile engine.

### BRIEF DESCRIPTION OF THE DRAWING

The advantages and features of the present disclosure will become better understood with reference to the following detailed description and claims taken in conjunction with the accompanying drawings, and in which:

FIG. 1 is a schematic diagram of one embodiment of a device for improving fuel efficiency of an automobile engine; and

FIG. 2 is a schematic diagram of one embodiment of a discharging circuit of the device.

Like reference numerals refer to like parts throughout the description of several views of the drawings.

### DETAILED DESCRIPTION OF THE DISCLOSURE

The exemplary embodiments described herein in detail for illustrative purposes are subject to many variations in structure and design. It should be emphasized, however, that the present invention is not limited to a particular device for discharging excess energy from an automobile engine, as shown and described. It is understood that various omissions and substitutions of equivalents are contemplated as circumstances may suggest or render expedient, but these are intended to cover the application or embodiment without departing from the spirit or scope of the claims of the present invention. Also, it is to be understood that the phraseology and terminology used herein are for the purpose of description and should not be regarded as limiting.

The terms “a” and “an” herein do not denote a limitation of quantity, but rather denote the presence of at least one of the referenced item.

The use of “including,” “comprising,” or “having” and variations thereof herein is meant to encompass the items listed thereafter and equivalents thereof as well as additional items.

Further, the use of terms “first”, “second”, and “third”, and the like, herein do not denote any order, quantity, or importance, but rather are used to distinguish one element from another.

Unless limited otherwise, the terms “attached” and “coupled” and variations thereof are not restricted to physical or mechanical attachments or couplings.

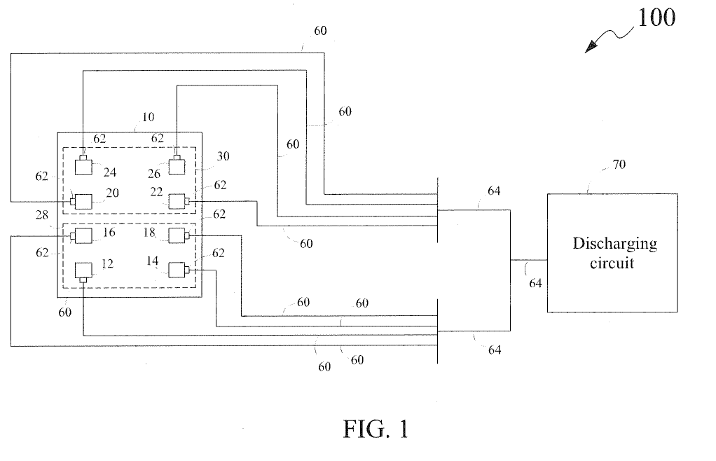

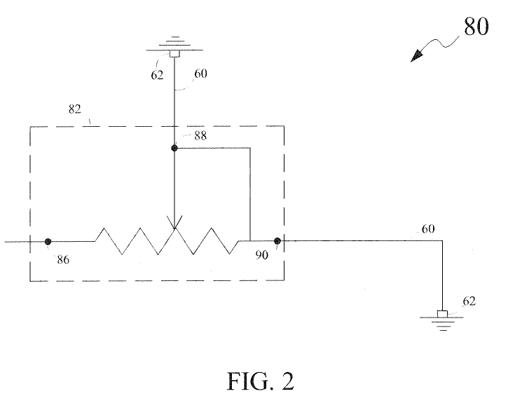

The present disclosure provides a device for improving fuel efficiency of an automobile engine that includes a plurality of firing cylinders having a plurality of firing caps. The device includes a first diode element, a second diode element, and a discharging circuit. Both the first diode element and the second diode element include an input terminal, and an output terminal. The input terminal of the first diode element is capable of being electrically coupled to a first set of firing caps of the plurality of firing caps. The output terminal of the second diode element is capable of being electrically coupled to a second set of firing caps of the plurality of firing caps. Further, the discharging circuit is electrically coupled to the output terminal of the first diode element and the output terminal of the second diode element. The discharging circuit is configured to receive excess energy from the automobile engine, and controllably discharge the excess energy into ground. The device of the present disclosure will now be explained in detail in conjunction with FIG. 1 and FIG. 2.

FIG. 1 is a schematic diagram of an embodiment of a device 100 for improving fuel efficiency of an automobile engine 10 of an automobile. The automobile engine 10 may include a plurality of firing cylinders (not shown), and a plurality of firing caps 12, 14, 16, 18, 20, 22, 24, and 26.

The ‘automobile engine 10’ as mentioned herein is a standard V engine with eight cylinders (‘V8 engine’) that is usually used to power heavy vehicles, such as trucks, and sports utility vehicles (SUVs). More specifically, the automobile engine 10 is a V8 engine that may include eight firing cylinders mounted on a crankcase in two banks of four firing cylinders. However, it should be understood that such reference to a V8 engine is only for exemplary purposes and should not be construed as a limitation to the present disclosure. Therefore, the present disclosure may be equally applicable to other automobile engines, such as a V6 engine, or any other automobile engine.

The device 100 may include a first diode element 40. The first diode element 40 may include an input terminal 42 that is capable of being electrically coupled to a first set of firing caps 28, which may include the firing caps 12, 14, 16, and 18. However, it should be understood that such electrical coupling of the input terminal 42 to the first set of firing caps 28 is only for exemplary purposes and should not be construed as a limitation to the present disclosure. Accordingly, the input terminal 42 may be electrically coupled to other firing caps 20, 22, 24, and 26. Further, the first diode element 40 may also include an output terminal 44.

The first diode element 40 may be similar to two-terminal P-N junction diodes known in the art. Further, the first diode element 40 may be a solid state diode, a gaseous state diode, or any other type of diode known in the art. Furthermore, the first diode element 40 may be composed of semiconductor materials, or any other materials that are known in the art for making diodes.

The device 100 may further include a second diode element 50. The second diode element 50 may include an input terminal 52 that is capable of being electrically coupled to a second set of firing caps 30, which may include the firing caps 20, 22, 24, and 26. However, it should be understood that such electrical coupling of the input terminal 52 to the second set of firing caps 30 is only for exemplary purposes and should not be construed as a limitation to the present disclosure. Alternatively, the input terminal 52 may be electrically coupled to other firing caps 12, 14, 16, and 18. Further, the second diode element 50 may also include an output terminal 54.

Further, like the first diode element 40, the second diode element 50 may be similar to two-terminal P-N junction diodes known in the art. Furthermore, the second diode element 50 may be a solid state diode, a gaseous state diode, or any other type of diode known in the art. Moreover, the second diode element 50 may be composed of semiconductor materials, or any other materials that are known in the art for making diodes.

The device 100 may also include a discharging circuit 70. The discharging circuit 70 may be configured to receive excess energy from the automobile engine 10, and more specifically, from the output terminal 44 of the first diode element 40 and the output terminal 54 of the second diode element 50. Further, the discharging circuit 70 may be configured to discharge the received excess energy into the ground.

In one embodiment, the discharging circuit 70 may include a potentiometer-diode circuit, such as potentiometer-diode circuit 80 of FIG. 2. As shown in FIG. 2, the potentiometer-diode circuit 80 may include a potentiometer circuit 82. The potentiometer circuit 82 may include an input terminal 86, which may be electrically coupled to the output terminal 44 of the first diode element 40, and the output terminal 54 of the second diode element 50. The electrical coupling configures the potentiometer-diode circuit 80 to receive the excess energy from the automobile engine 10.

Further, the potentiometer circuit 82 may also include a first output terminal 88, which may be capable of being electrically coupled to the ground. More specifically, the first output terminal 88 may be capable of being electrically coupled to an insulated part of the automobile. The insulated part of the automobile may be a side wall of the automobile. Further, the electrical coupling of the first output terminal 88 to the ground enables a controllable discharge of the excess energy received by the potentiometer circuit 82 to the ground. More specifically, the first output terminal 88 may be a wiper terminal that provides varying resistance mechanism in a conventional potentiometer device.

Furthermore, the potentiometer circuit 82 may include a second output terminal 90, which may also be capable of being electrically coupled to the ground. More specifically, the second output terminal 90 may also be capable of being electrically coupled to the insulated part of the automobile. Further, the electrical coupling of the second output terminal 90 to the ground enables a controllable discharge of the excess energy to the ground. In one embodiment, the second output terminal 90 may be an output terminal of a conventional potentiometer device.

Further, the potentiometer-diode circuit 80 may include a third diode element 84. The third diode element 84 may include an input terminal 92. The second output terminal 90 of the potentiometer circuit 82 may be electrically coupled to the input terminal 92. The third diode element 84 may further include an output terminal 94, which may be electrically coupled to the ground for controllably discharging the excess energy to the ground. It should be understood that the third diode element 84 may be similar to two-terminal P-N junction diodes known in the art. Further, the third diode element 84 may be a solid state diode, a gaseous state diode, or any other type of diode known in the art. Furthermore, the third diode element 84 may be composed of semiconductor materials, or any other materials that are known in the art for making diodes.

The device 100 may also include a set of electrical wires 60. The set of electrical wires 60 may be used for the electrically coupling the first set of firing caps 28 to the input terminal 42, the second set of firing caps 30 to the input terminal 52, the first output terminal 88 of the potentiometer circuit 82 to the ground, and the output terminal 94 of the third diode element 84 to the ground. Further, the electrical wires 60 may be similar to electrical wires known in the art. In one embodiment, the electrical wires 60 may include electrical clamps 62 configured at an end portion thereof for providing an electrical connection required for the electrical coupling. Further, the device 100 may also include circuitry wires 64 for providing internal electrical coupling, such as the electrical coupling between the output terminal 44 and the input terminal 86 of the potentiometer circuit 82, and other such electrical couplings in the device 100.

In use, a user may install the device 100 in the automobile engine 10, for discharging the excess energy from the automobile engine 10. The installation of the device 100 may include electrically coupling the first set of firing caps 28 and the second set of firing caps 30, of the automobile engine 10 to the input terminal 42 and the input terminal 52 of the device 100. The electrical coupling may be done by the user using the set of electrical wires 60. Further, the installation may include electrically coupling the first output terminal 88 of the potentiometer circuit 82 and the output terminal 94 of the third diode element 84 to ground. The grounding of the first output terminal 88 and the output terminal 94 may include electrically coupling such terminals to the insulated parts of the automobile using the set of electrical wires 60.

During operation of the device 100, the excess energy may be transferred from the automobile engine 10 to the device 100. More specifically, the excess energy may be received by the discharging circuit 70 of the device 100. The receiving of the excess energy may be through the first diode element 40 and the second diode element 50. On the receiving of the excess energy, the discharging circuit 70 may control the discharge of the excess energy into the ground. More specifically, the discharging circuit 70 may use the regulation mechanism provided in the first output terminal 88 for regulating the amount of the excess energy that is discharged by the discharging circuit 70 in the ground.

The discharge of the excess energy in such manner may prevent the accumulation of the excess energy in the automobile engine 10, thereby improving the fuel efficiency of the automobile engine 10. More specifically, the discharging of the excess energy may remove unnecessary energy that may have otherwise interfered with true power of the automobile engine 10, thereby increasing the driving power available to the automobile. Accordingly, the automobile may travel a greater distance by burning a same amount of fuel, thereby improving the fuel efficiency of the automobile engine 10.

In addition to the foregoing description of the device 100, and with respect to shapes and sizes of various components thereof, it should be understood that the device 100 may be manufactured in various customized sizes. Furthermore, the device 100 may be composed of various materials, and may be operated in various ways based on the method of manufacturing. Moreover, the device 100 may also include an insulating container member for retaining and insulating various electrical components, such as diodes, and electrical circuitry, of the device 100.

Based on the foregoing, the present disclosure provides a device, such as the device 100, for improving fuel efficiency of an automobile engine. The device may be easily installed by a user in his/her automobile engine. The device may provide an increase in fuel efficiency of about 25 percent to about 50 percent. The device may be specifically useful for heavy vehicles that usually suffer from high fuel consumption. Further, the device includes a discharging circuit, such as the discharging circuit 70, which ensures that the discharge of excess energy present in the automobile engine in the ground is in a controlled manner. Such controlled discharge of the excess energy makes the device safe to use. Moreover, the device utilizes easily available electrical components, such as diodes, and electrical circuits, such as the potentiometer circuit 82, thereby making the device both easy and cheap to manufacture.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. A device for improving fuel efficiency of an automobile engine, the automobile engine comprising a plurality of firing cylinders having a plurality of firing caps, the device comprising:
a first diode element having,
an input terminal capable of being electrically coupled to a first set of firing caps of the plurality of firing caps, and
an output terminal;
a second diode element having,
an input terminal capable of being electrically coupled to a second set of firing caps of the plurality of firing caps, and
an output terminal; and
a discharging circuit electrically coupled to the output terminal of the first diode element and the output terminal of the second diode element, the discharging circuit configured to,
receive excess energy from the automobile engine through the output terminal of the first diode element and the output terminal of the second diode element, and
controllably discharge the excess energy into ground,
wherein the discharge of the excess energy into the ground prevents accumulation of the excess energy in the automobile engine, thereby improving the fuel efficiency of the automobile engine.

2. The device of claim 1, wherein the discharging circuit comprises a potentiometer-diode circuit comprising:
a potentiometer circuit having,
an input terminal electrically coupled to the output terminal of the first diode element and the output terminal of the second diode element for receiving the excess energy from the automobile engine,
a first output terminal capable of being electrically coupled to the ground for controllably discharging the excess energy to the ground, and
a second output terminal; and
a third diode element having,
an input terminal electrically coupled to the second output terminal of the potentiometer circuit, and
an output terminal capable of being electrically coupled to the ground for controllably discharging the excess energy to the ground.

3. The device of claim 2, wherein the first output terminal of the potentiometer circuit comprises a wiper terminal of the potentiometer circuit.

4. The device of claim 1 further comprising a set of electrical wires configured to,
electrically couple the first diode element to the first set of firing caps of the plurality of firing caps,
electrically couple the second diode element to the second set of firing caps of the plurality of firing caps, and
controllably discharge the excess energy into the ground.

5. A device for improving fuel efficiency of an automobile engine, the automobile engine comprising a plurality of firing cylinders having a plurality of firing caps, the device comprising:
a discharging circuit comprising,
an input terminal capable of being electrically coupled to the plurality of firing caps and configured to receive excess energy from the automobile engine, and
at least one output terminal capable of being electrically coupled to ground,
wherein the discharging unit is capable of controllably discharging the excess energy into the ground through the output terminal, and wherein the discharge of the excess energy into the ground prevents accumulation of the excess energy in the automobile engine, thereby improving the fuel efficiency of the automobile engine.
